(19) United States
(12) Patent Application Publication
(10) Pub. No.: US 2012/0075354 A1
(43) Pub. Date: Mar. 29, 2012

(54) CAPTURE TIME REDUCTION FOR CORRECTION OF DISPLAY NON-UNIFORMITIES

(75) Inventors: Yeping Su, Camas, WA (US); Xiaofan Feng, Camas, WA (US)

(73) Assignee: SHARP LABORATORIES OF AMERICA, INC., Camas, WA (US)

(21) Appl. No.: 12/893,525

(22) Filed: Sep. 29, 2010

(51) Int. Cl. G09G 5/10

(52) U.S. Cl. 345/690

(57) ABSTRACT

A display includes a plurality of gray levels being provided to a plurality of pixels of the display and illuminating each of the pixels with the plurality of gray levels. The display applying corrective data for the pixels so as to reduce the mura effects of the display for the plurality of gray levels, wherein a selection of code values for the corrective data is determined based upon a minimization of an error function.

### CROSS-REFERENCE TO RELATED APPLICATIONS

None.

### BACKGROUND OF THE INVENTION

The present invention relates to a system for reducing mura defects in a displayed image in an efficient manner.

The number of liquid crystal displays, electroluminescent displays, organic light emitting devices, plasma displays, and other types of displays are increasing. The increasing demand for such displays has resulted in significant investments to create high quality production facilities to manufacture high quality displays. Despite the significant investment, the display industry still primarily relies on the use of human operators to perform the final test and inspection of displays. The operator performs visual inspections of each display for defects, and accepts or rejects the display based upon the operator's perceptions. Such inspection includes, for example, pixel-based defects and area-based defects. The quality of the resulting inspection is dependent on the individual operator which are subjective and prone to error.

“Mura” defects are contrast-type defects, where one or more pixels is brighter or darker than surrounding pixels, when they should have uniform luminance. For example, when an intended flat region of color is displayed, various imperfections in the display components may result in undesirable modulations of the luminance. Mura defects may also be referred to as “Alluk” defects or generally non-uniformity distortions. Generically, such contrast-type defects may be identified as “blobs”, “bands”, “streaks”, etc. There are many stages in the manufacturing process that may result in mura defects on the display.

Mura defects may appear as low frequency, high-frequency, noise-like, and/or very structured patterns on the display. In general, most mura defects tend to be static in time once a display is constructed. However, some mura defects that are time dependent include pixel defects as well as various types of non-uniform aging, yellowing, and burn in. Display non-uniformity deviations that are due to the input signal (such as image capture noise) are not considered mura defects.

Referring to FIG. 1, mura defects from an input image 170 which is adjusted in its tone scale 160 may occur as a result of various components of the display. The combination of the light sources (e.g., fluorescent tubes or light emitting diodes) and the diffuser 150 results in very low frequency modulations as opposed to a uniform field in the resulting displayed image. The LCD panel itself may be a source of mura defects because of non-uniformity in the liquid crystal material deposited on the glass. This type of mura tends to be low frequency with strong asymmetry, that is, it may appear streaky which has some higher frequency components in a single direction. Another source of mura defects tends to be the driving circuitry 120, 130, 140 (e.g., clocking noise) which causes grid like distortions on the display. Yet another source of mura defects is pixel noise, which is primarily due to variations in the localized driving circuitry (e.g., the thin film transistors) and is usually manifested as a fixed pattern noise.

The continual quality improvement in display components reduces mura defects but unfortunately mura defects still persist even on the best displays. Referring to FIG. 1, identification of mura defects is not straightforward because the source of the mura arise in different luminance domains. The mura resulting from the illumination source occurs in the linear luminance domain. To compensate for this effect from the linear domain, the LCD luminance image is divided by the mura and then re-normalized to the desired maximum level. This effect in the linear domain may also be compensated by addition in the log domain. Unfortunately, the data displayed on the image domain of the image in the LCD code value space is neither linear nor log luminance. Accordingly, for correction of illumination-based mura, the LCD image data should be converted to either of these domains for correction.

The mura defects due to the thin film transistor noise and driver circuits does not occur in the luminance domain, but rather occurs in the voltage domain. The result manifests itself in the LCD response curse which is usually an S-shaped function of luminance.

Variations in the mura effect due to variations in liquid crystal material occur in yet another domain, depending on if it is due to thickness of the liquid crystal material, or due to its active attenuation properties changing across the display.

Rather than correct for each non-uniformity in their different domains, a more brute-force approach is to measure the resulting tone scale for each pixel of the display. The low frequency mura non-uniformities as well as the higher frequency fixed pattern mura non-uniformity will appear as distortions in the displayed tone scale. For example, additive distortions in the code value domain will show up as vertical offsets in the tone scale's of the pixels affected by such a distortion. Illumination based distortions which are additive in the log domain will show up as non-linear additions in the tone scale. By measuring the tone scale per pixel, where the tone scale is a mapping from code value to luminance, the system may reflect the issues occurring in the different domains back to the code value domain. If each pixel's tonescale is forced to be identical (or substantially so), then at each gray level all of the pixels will have the same luminance (or substantially so), thus the mura will be reduced to zero (or substantially so).

In summary, referring to FIG. 2, the process of detecting and correcting for mura defects may be done as a set of steps. First for a uniform test input image 220, the capture and generation of the corrective tone scale 230, 240 is created which may be expressed in the form of a look up table. Second, referring to FIG. 3 the corrective tone scale may be applied to a mura look up table 310 which operates on the frame buffer memory of the display. Third, referring to FIG. 4, the display is used to receive image data 170 which is modified by the mura look up table 310, prior to being displayed on the display.

The first step may use an image capture device, such as a camera, to capture the mura as a function of gray level. The camera should have a resolution equal to or greater than the display so that there is at least one pixel in the camera image corresponding to each display pixel. For high resolution displays or low resolution cameras, the camera may be shifted in steps across the display to characterize the entire display. The preferable test patterns provided to and displayed on the display include uniform fields (all code values=k) and captured by the camera. The test pattern and capture are done for all of the code values of the displays tone scale (e.g., 256 code values for 8 bit/color display). Alternatively, a subset of the tone scales may be used, in which case typically the non-sampled tone values are interpolated.

The captured images are combined so that a tone scale across its display range is generated for each pixel (or a sub-set thereof). If the display has zero mura, then the corrective mura tone scales would all be the same. A corrective tone scale for each pixel is determined so that the combination of the corrective tone scale together with the system non-uniformity provides a resulting tone scale that is substantially uniform across the display. Initially, the values in the mura correction tone scale look up table may be set to unity before the display is measured. After determining the corrective mura tone scale values for each pixel, it is loaded into the display memory as shown in FIG. 4. With the mura corrective tone scale data loaded any flat field will appear uniform, and even mura that may be invisible on ramped backgrounds, such as a sky gradient, will be set to zero.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates liquid crystal devices and sources of mura.

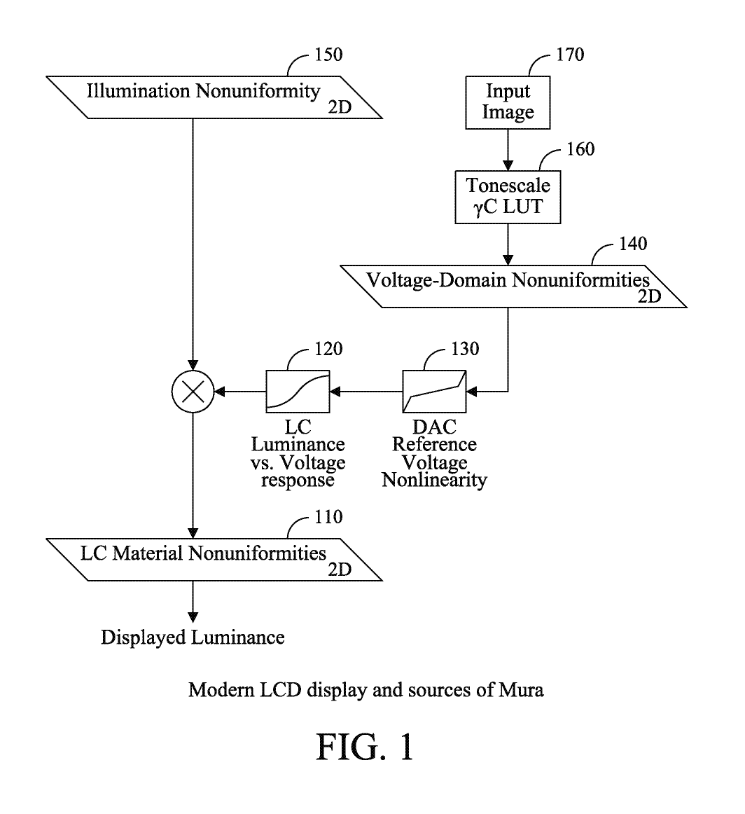

FIG. 2 illustrates capturing mura tonescale.

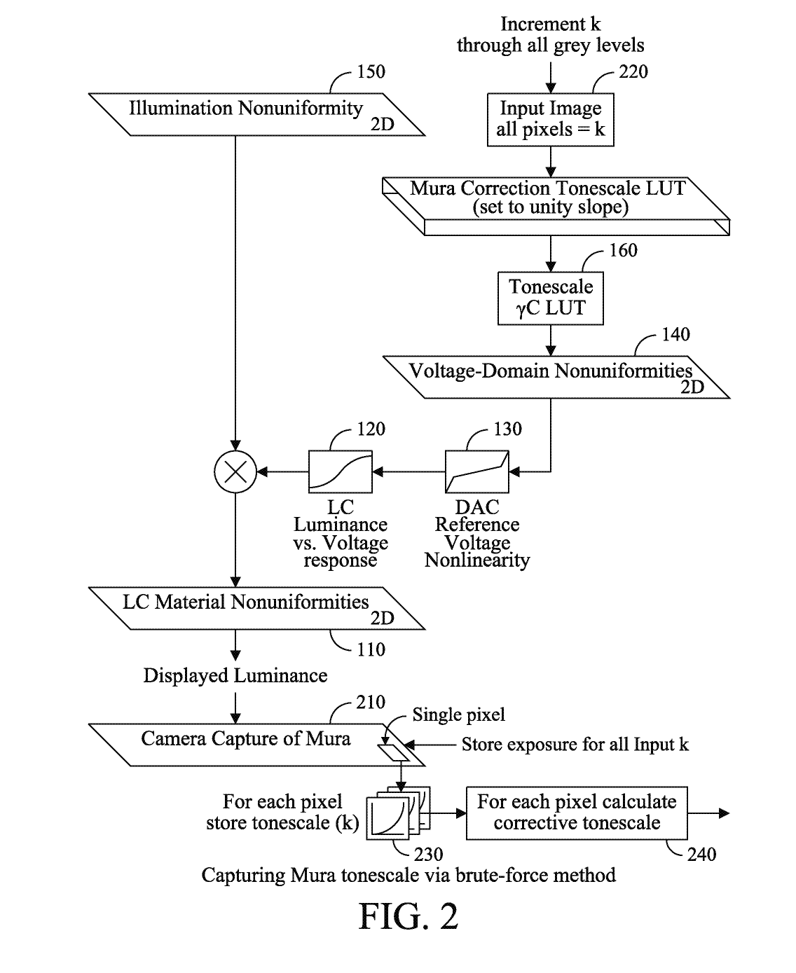

FIG. 3 illustrates loading correction mura tonescales.

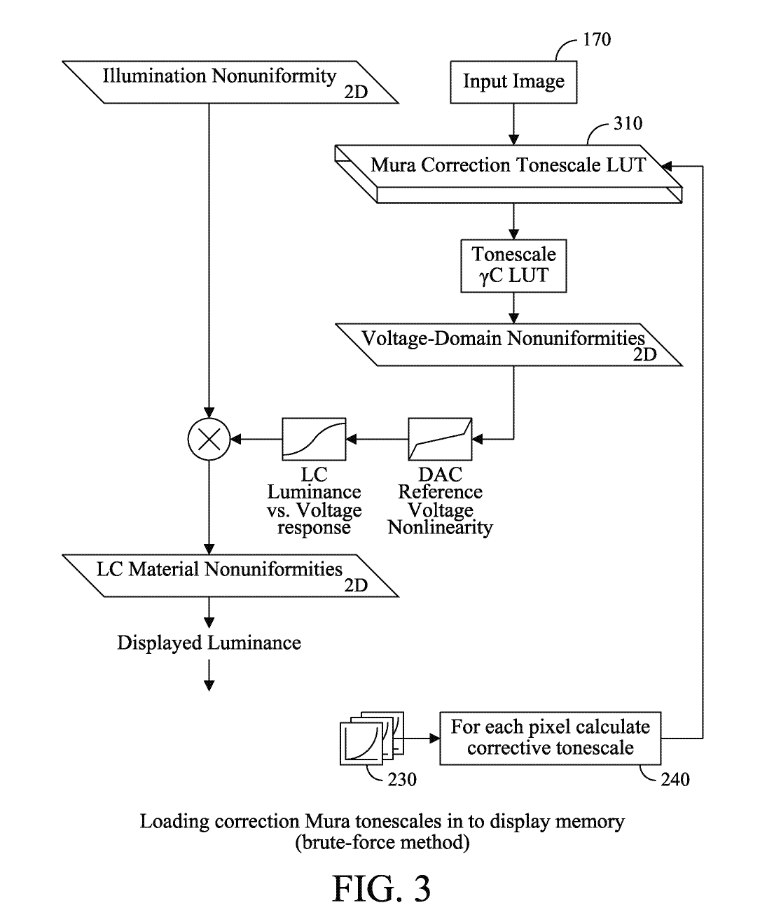

FIG. 4 illustrates input imagery and loaded mura correction tonescale.

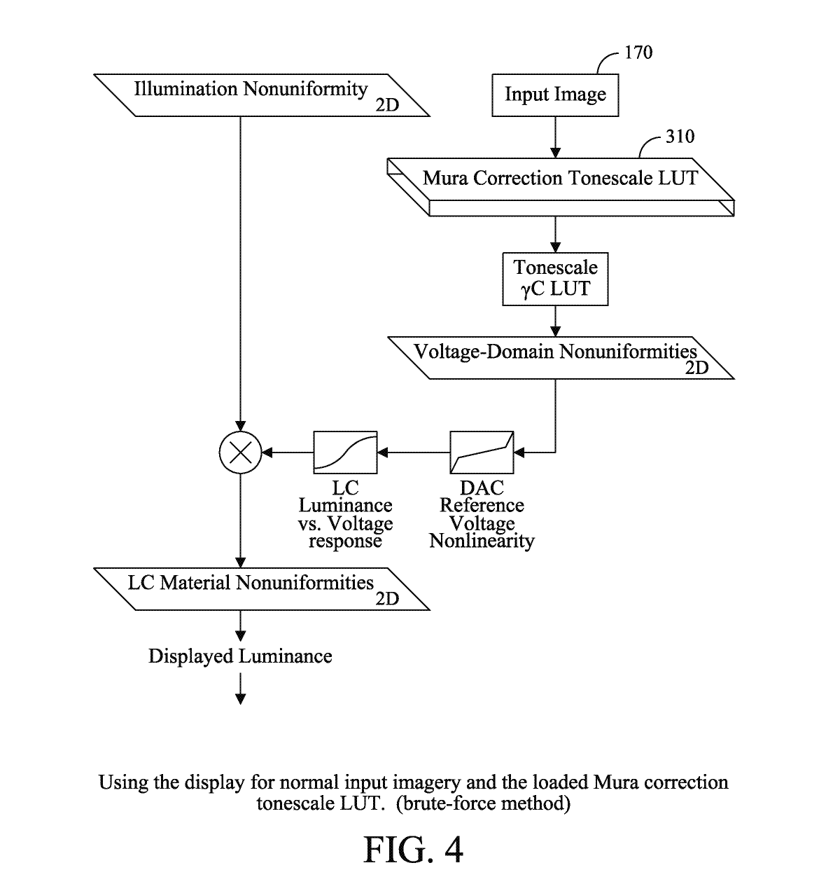

FIG. 5 illustrates a Mura reduction system.

FIG. 6 illustrates a Mura capture time reduction.

FIG. 7 illustrates color based Mura reduction.

### DETAILED DESCRIPTION OF THE PREFERRED EMBODIMENT

Existing techniques for correcting display non-uniformity are based upon multiple camera captures in order to cover the whole display luminance range. The more camera captures that are required for the technique, the more time that is required to obtain the desired measurements. While suitable for low-volume characterization, when there are time limitations in a production environment this characterization technique requires a significant amount of time. Accordingly, the brute force technique of measuring mura data for each code value of the display tone scale (e.g., 256 for an 8 bit display) may require longer to complete than the time available. Similarly, an interpolative approach for Mura measurements for only a subset of the code values (e.g., on the set [31, 63, 95, 127, 191, 255] for luminance correction) uses a smaller set but is generally not an optimal selection of code value. In addition, the time to obtain suitable Mura measurements is code value dependent. For example, a low code value such as 15 takes a longer time to obtain a suitable exposure compared to a high code value such as 192. Such measurement time information may be incorporated in selecting an optimal set of code values for Mura reduction while likewise improving the selection of the Mura code value set. Thus, it is desirable to reduce the capture time for obtaining data for Mura correction, while likewise improving Mura correction qualities.

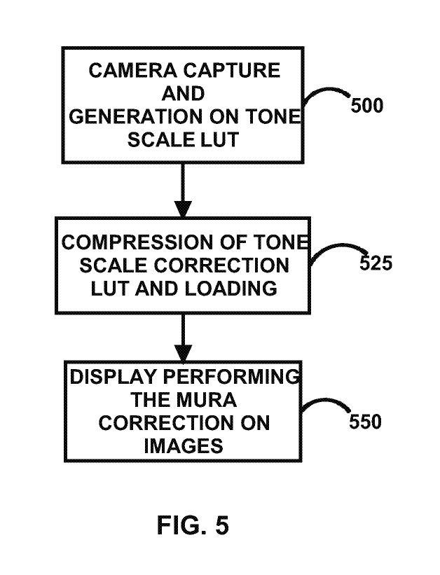

Referring to FIG. 5, the Mura capture and correction system may include camera capture and generation of tone scale correction look up tables (“LUTs”) 500, compression of tone scale correction look up tables and loading the compressed data into display integrated circuits 525, and the display performing the Mura correction on images being displayed using reconstructed tone scale correction look up tables 550.

The measurement of the individual display characteristics for Mura correction typically occurs on the factory floor, where it is desirable to reduce the duration of camera capture and processing on each display as much as possible. Thus it is desirable to reduce the total number of camera captures and likewise reduce the total exposure time. A desirable technique which permits those goals is a training-based Mura reduction technique. Initially during an offline training phase for a typical exemplary display panel (or panels), the system collects densely captured Mura data and determines a sparse set of code values that can provide a suitable approximation of the whole dense data set. Then during the production phase, additional Mura data is captured for code values in the sparse set for the production displays. By using a relatively small number of camera captures for the production displays, the system may achieve the desired time saving while at the same time having suitable Mura correction.

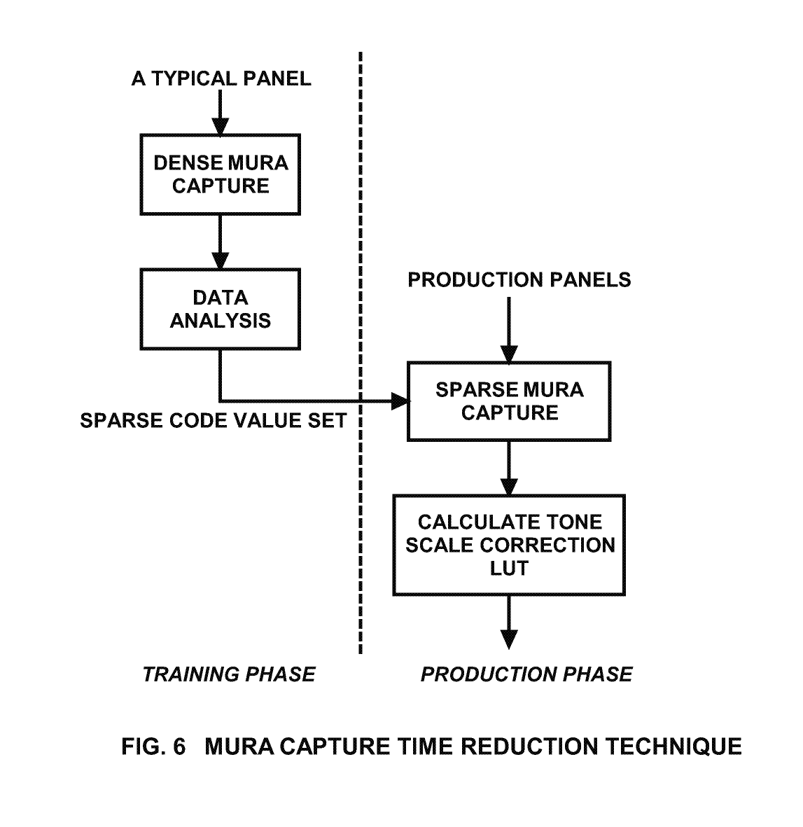

Referring to FIG. 6, a typical panel (or set of panels) is selected from a batch of panels to be Mura corrected or otherwise characterized. A typical panel is representative of the Mura characteristics among the larger group of panels. A dense Mura capture is performed on the typical panel (or panels). Without loss of generality, it may be assumed that the system has one capture for each code value and the resulting data is denoted as {I[i], 0≦i≦2^{b}−1} for b-bit/color panel. Alternatively, fewer code value may be used as desired. Each capture contains an image I[i] with the same spatial resolution as the display panel. Alternatively, a spatial resolution of less than the display panel may likewise be used. The capture time for each code value may be recorded as {t[i], 0≦i≦2^{b}−1}. In order to achieve suitable exposure time, the capture time is typically longer for lower code values than of higher code values. If a total capture time constraint is desired, then the timing information for each code value may be used as an additional basis for the code value selection.

A data analysis process is carried out on the captured dataset {I[i], 0≦i≦2^{b}−1}, potentially with the corresponding capture time estimate {t[i], 0≦i≦2^{b}−1}. The outcome of the analysis process is to determine a sparse set of code values {CV[j], 0≦j≦J−1} on which Mura measurements may be taken for a large group of panels for the production phase. The total number of captures J may be set as a system parameter.

In the production phase, perform Mura measurements with the set of code values determined in the analysis step {CV[j], 0≦j≦J−1}. There is other information that may be used to provide improved data analysis. For production panels, an interpolation technique may be used to calculate Mura correction values for code values not included in the sparse set. This is indicated as a function of the capture set: Ĩ[i]=f(i,{CV[j], I[CV[j]], 0≦j≦J−1}), 0≦i≦2^{b}−1. Preferably linear interpolation is used, while any other interpolation technique may be used. Given an interpolated Mura corrected image and the corresponding captured ground truth image, an error measure may be defined. This error function may be the mean square error between the two images, a color difference measure in a perceptually uniform color space such as delta-E evaluated on Mura corrected images, or any other error function. This error function may be denoted as Err(Ĩ[i], I[i]). The total error function is the summation of the error function Err(Ĩ[i], I[i]) over all (or selected set of) code values as a measure of display quality.

In more detail for the data analysis module, the total number of captures J may be a constraint. Given {I[i], 0≦i≦2^{b}−1} and J, the problem can be formulated as:

$$\{ CV [ j ] , 0 \leq j \leq J - 1 \} = {arg min}_{\{ CV [ j ] , 0 \leq j \leq J \}} {\sum }_{i = 0}^{{2}^{b} - 1} Err ( f ( i , \{ CV [ j ] , I [ CV [ j ] ] , 0 \leq j \leq J - 1 \} ) , I [ i ] ) .$$

The above optimization problem can be solved using a brute force search. Considering there possible

$$( \begin{matrix}{2}^{b} \\ J\end{matrix} )$$

combinations for the sparse set, one can find the best combination by enumeration and picking the one with smallest total error.

Although the brute force search technique can guarantee an optimal solution, the associated computational cost might too high for certain applications. The following search technique is a more computationally efficient alternative. In general, the technique keeps improving the solution by shifting each code value around and finding the one that gives the greatest reduction in the total error as follows:

First set iteration number k=0. Set initial solution {CV⁰[j], 0≦j≦J−1} as evenly spaced values between the lowest code value and the highest code value, excluding both ends. Then repeat the following process until the maximal iteration number is reached or the reduction of total error is below certain threshold. For each 0≦j≦J−1, loop over code values between CV^{k}[j−1] and CV^{k}[j+1] (while keeping all other code values the same) and pick the one CV^{k}[j]′ that provides the biggest reduction in the total error. Among {CV^{k}[j]′, 0≦j≦J−1}, pick the one CV^{k}[j*]′ that provides the biggest reduction in the overall error function and set CV^{k}[j*]′→CV^{k}[j*]. And set k=k+1.

The optimization may be further be constrained based on the total capture time. Given the dense Mura capture data {I[i], 0≦i≦2^{b}−1}, the target number of captures J, capture time estimates {t[i], 0≦i≦2^{b}−1}, and the maximal total capture time T, the problem can be formulated as follows:

$$\{ CV [ j ] , 0 \leq j \leq J - 1 \} = {arg min}_{\{ CV [ j ] , 0 \leq j \leq J - 1 \}} {\sum }_{i = 0}^{{2}^{b} - 1} Err ( f ( i , \{ CV [ j ] , I [ CV [ j ] ] , 0 \leq j \leq J - 1 \} ) , I [ i ] ) subject to T \geq {\sum }_{j = 0}^{J - 1} t [ CV [ j ] ]$$

Again the optimization problem above can be solved using a brute force search. A code value set is considered sufficient only when the total capture time constraint is satisfied. For all such combinations, the one that optimizes the total error is the optimal solution. The preferred search technique can also be modified to incorporate the total capture time constraint as follows. Initially, set iteration number k=0. Set initial solution {CV⁰[j], 0≦j≦J−1} as evenly spaced values between the lowest code value and the highest code value, excluding both ends. Notice that the initial solution is assumed to satisfy the total capture time constraint. Repeat the following process until the maximal iteration number is reached or the reduction of total error is below a certain threshold. Then for each 0≦j≦J−1, loop over code values between CV^{k}[j−1] and CV^{k}[j+1] (while keeping all other code values the same) and pick the one CV^{k}[j]′ that provides the biggest reduction in the total error while satisfying the total capture time constraint. Also among {CV^{k}[j]′, 0≦j≦J−1}, pick the one CV^{k}[j*]′ that provides the biggest reduction in the overall error function and set CV^{k}[j*]′→CV^{k}[j*]. Then set k=k+1.

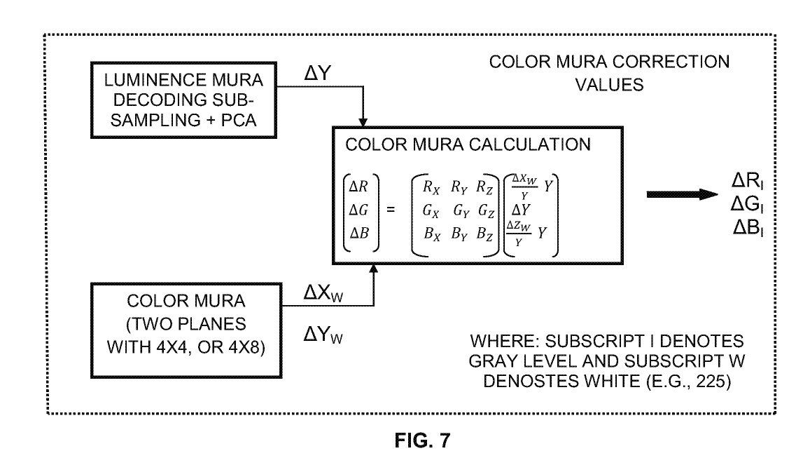

Referring to FIG. 7, color Mura correction may include data capture in all the color channels such as RGB or RGBY, thus requiring more time in capturing and subsequent computation. Since most of the color Mura is caused by either the backlight or the color filters, it is highly correlated from different gray levels. Initially, set the display to maximum red, green and blue, and capture the display. Then derive the CIE XYZ from the captured RGB.

$$( \begin{matrix}X \\ Y \\ Z\end{matrix} ) = ( \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ) ( \begin{matrix}R \\ G \\ B\end{matrix} )$$

Then tri-stimulus to chromaticities (x and y) and Luminance (Y): XYZ→xyY. Color Mura correction may be provided in the opponent color space (xyY processing), including luminance Y band pass CSF, multi-pass technique at the maximum luminance (ΔY), and chrominance x and y low passing filtering based on the characteristics of HVS (Δx and Δy). Then convert the Mura correction back to RGB

$$( \begin{matrix}Δ R \\ Δ G \\ Δ B\end{matrix} ) = ( \begin{matrix}{R}_{x} & {R}_{y} & {R}_{z} \\ {G}_{x} & {G}_{y} & {G}_{z} \\ {B}_{x} & {B}_{y} & {B}_{z}\end{matrix} ) ( \begin{matrix}\frac{Δ x}{y} Y \\ Δ Y \\ \frac{Δ z}{y} Y\end{matrix} ) .$$

One advantage of opponent processing includes better visual quality due to reduced noise and avoids blotchy color variation in RGB processing.

The image information stored in the look up table of the display is preferably compressed to reduce storage requirements. For example, the technique may captures the following six gray levels [2, 31, 63, 118, 182, 255]. While the display could store all six gray levels, it is preferable that the data is processed so that a smaller set of gray levels may be determined, where the six gray levels are linear combinations (or otherwise any type of combination, including for example, a deterministic interpolation, polynomial interpolation, and/or spline interpolation) of the smaller set of gray levels. For example gray level images PC_0 and PC_1 may be stored, where the gray levels [2, 31, 63, 118, 182, 255] are linear combinations thereof. The coefficient data to determine the gray levels [2, 31, 63, 118, 182, 255] is likewise provided. The display, thereafter, uses the gray level images PC_0 and PC_1 and the coefficient data to generate each of the gray levels for the display (inclusive of each gray level for each color channel).

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A display comprising:
(a) a plurality of gray levels being provided to a plurality of pixels of said display;
(b) said display illuminating each of said pixels with said plurality of gray levels;
(c) said display applying corrective data for said pixels so as to reduce the mura effects of said display for said plurality of gray levels, wherein a selection of code values for said corrective data is determined based upon a minimization of an error function.

2. The display of claim 1 wherein said corrective data is based upon display measurements.

3. The display of claim 1 wherein said plurality of grey levels is less than all available grey levels.

4. The display of claim 1 wherein said corrective data is based upon characterizing another display for mura effects.

5. The display of claim 4 wherein said corrective data includes a sparse data set.

6. The display of claim 5 wherein said sparse data set is based upon said error function.

7. The display of claim 4 wherein said corrective data is based upon a capture time constraint.

8. The display of claim 4 wherein said corrective data is based upon a multi-color image.

9. The display of claim 1 wherein said selection of code values is stored in a display using a reduced set of data that are combinations of said selection of code values.
